(19) United States
(12) Patent Application Publication
(10) Pub. No.: US 2019/0109737 A1
(43) Pub. Date: Apr. 11, 2019

(54) Receiving Device and Method Thereof

(71) Applicant: Huawei Technologies Co., Ltd., Shenzhen (CN)

(72) Inventors: Chaitanya Tumula, Kista (SE); Alberto Diego Jimenez Feltstrom, Kista (SE); Junshi Chen, Kista (SE); Peter Almers, Kista (SE); Sergei Semenov, Kista (SE)

(21) Appl. No.: 16/213,666

(22) Filed: Dec. 7, 2018

Related U.S. Application Data
(63) Continuation of application No. PCT/EP2016/062964, filed on Jun. 8, 2016.

(51) Int. Cl. H04L 25/03; H04B 1/7105; H04B 7/0456; H04L 27/34

(52) U.S. Cl. CPC H04L 25/03312; H04L 25/03197; H04L 27/34; H04B 7/046; H04B 1/71057

(57) ABSTRACT

The application relates to a receiving device for a communication system, where the receiving device includes a receiver configured to receive a Multiple-Input and Multiple-Output (MIMO) communication signal including a plurality of transmit symbols belonging to at least one complex-valued symbol constellation, a processing circuit configured to affine-transform the at least one complex-valued symbol constellation to obtain at least one affine-transformed complex-valued symbol constellation, compute a decision metric; based on the at least one affine-transformed complex-valued symbol constellation, detect the transmit symbols based on the computed decision metric.

### CROSS-REFERENCE TO RELATED APPLICATIONS

This application is a continuation of International Patent Application No. PCT/EP2016/062964 filed on Jun. 8, 2016, which is hereby incorporated by reference in its entirety.

### TECHNICAL FIELD

The application relates to a receiving device for wired or wireless communication systems, or combinations thereof. Furthermore, the application also relates to a corresponding method, a wired or wireless communication system, a computer program, and a computer program product.

### BACKGROUND

Multiple-Input and Multiple-Output (MIMO) is an effective technology to improve the data rate in communication systems. In Long Term Evolution (LTE) release 10, an 8-layer transmission is supported and the data rate can reach 3 gigabits per second (Gbps).

MIMO detection for large number of transmission layers is a challenging problem with high complexity.

Various MIMO detection methods have been proposed in the art which have varying degrees of complexity and performance. Some of the detection methods includes the following.

Linear equalization, e.g., Minimum Mean-Square Error (MMSE).

Matrix decomposition based methods, e.g., Sphere Decoder and its variants, which use tree-search based MIMO detection.

Reduced complexity tree-search methods like K-Best or QR Decomposition (QRD)-M.

MMSE has less complexity at the price of poor performance. MMSE does not involve any decision metric of computation.

To achieve better performance with a reduced complexity, in sphere decoding, all the paths which exceed a given sphere radius distance are discarded. The path which lies within the given sphere radius and has the smallest decision metric is declared as the transmitted signal vector.

Similarly, in K-best and QRD-M algorithms, for complexity reduction, only a smaller subset of braches is retained at every node while traversing through a tree. All these methods evaluate the decision metric for a subset of possible transmitted signal vectors by computing the branch and accumulated metrics while traversing through a tree.

In a conventional solution, a method is proposed by which the complexity of performing MIMO detection is reduced. In the mentioned conventional solution, an equivalent real-valued MIMO system model is considered. The method proposed in the aforementioned conventional solution works only for real-valued equivalent MIMO detection methods. However, for reduced-complexity tree-search detection methods like the sphere decoding, K-best and QRD-M algorithm, we know that the performance of the tree-search using real-valued model is inferior compared to performing the tree-search using the complex valued model.

### SUMMARY

An objective of embodiments of the application is to provide a solution which mitigates or solves the drawbacks and problems of conventional solutions.

Another objective of embodiments of the application is to provide a solution which reduces complexity in a MIMO receiver. Especially, reducing the circuit complexity of MIMO detection.

The above objective and further objectives are achieved by the subject matter of the independent claims. Further advantageous implementation forms of the application are defined by the dependent claims.

According to a first aspect of the application, the above mentioned and other objectives are achieved with a receiving device for a MIMO communication system, the receiving device comprising a receiver configured to receive a MIMO communication signal comprising a plurality of transmit symbols belonging to at least one complex-valued symbol constellation, a processing circuit configured to affine-transform the at least one complex-valued symbol constellation so as to obtain at least one affine-transformed complex-valued symbol constellation, compute a decision metric based on the at least one affine-transformed complex-valued valued symbol constellation, detect the plurality of transmit symbols based on the computed decision metric.

A number of advantages are provided by a receiving device according to the first aspect. The affine-transformed constellations are used to compute the decision metric. The affine-transformations may be applied directly on the complex-domain signal constellations. The affine-transformed constellations consist of points which facilitate reduced-complexity algebraic operations for computation of decision metric. Hence, reduced circuit complexity as well as reduction of the processing delay for performing MIMO detection is obtained.

In a first possible implementation form of a receiving device according to the first aspect, the affine-transformation comprises scaling the complex-valued symbol constellation with at least one complex-valued scaling parameter.

In a second possible implementation form of a receiving device according to the first implementation form of the first aspect, the complex-valued scaling parameter has the form 1/β, where β is a complex number.

In a third possible implementation form of a receiving device according to the first or second implementation forms of the first aspect or to the first aspect as such, the affine-transformation comprises shifting the complex-valued symbol constellation with at least one complex-valued shifting parameter.

An advantage of the third possible implementation form using the affine transformed (shifted and scaled) signal constellation is that operation of performing a complex multiplication operation using the points from the transformed constellation becomes much simpler compared to the points from a non-transformed constellation. This also leads to less number of algebraic operations to be performed for computing decision metric for one hypothesis transmit symbol vector.

In a fourth possible implementation form of a receiving device according to the first or second implementation forms of the first aspect or to the first aspect as such, the affine-transformation comprises rotating the complex-valued symbol constellation with at least one complex-valued rotation parameter having unit modulus.

An advantage of the fourth possible implementation form using the affine transformed (rotated and scaled) signal constellation is that operation of performing the multiplication operation using the points from the transformed constellation becomes much simpler compared to the points from a non-transformed constellation. This also leads to less number of algebraic operations to be performed for computing decision metric for one hypothesis transmit symbol vector.

In a fifth possible implementation form of a receiving device according to the third or fourth implementation forms of the first aspect, the plurality of transmit symbols corresponds to different transmission layers, and wherein at least one of the complex-valued shifting parameter and the complex-valued rotation parameter is dependent on the transmission layers.

An advantage with this possible implementation form is that it provides flexibility of handling the scenarios in which the transmit symbols corresponding to different transmission layers belong to different complex-domain symbol constellations.

In a sixth possible implementation form of a receiving device according to any of the second to fifth implementation forms of the first aspect or to the first aspect as such, the detection of the plurality of transmit symbols comprises performing hard-decisions based on the computed decision metric.

An advantage with this possible implementation form is that it is a convenient way of performing detection using well known methods.

In a seventh possible implementation form of a receiving device according to any of the second to fifth implementation forms of the first aspect or to the first aspect as such, the detection of the plurality of transmit symbols comprises computing Log Likelihood Ratios (LLRs), for bits corresponding to the plurality of transmit symbols based on the computed decision metric.

An advantage with this possible implementation form is that it is a convenient way of performing detection using well known methods.

In an eight possible implementation form of a receiving device according to the seventh implementation form of the first aspect, the processing circuit is configured to scale the computed decision metric using a real-valued scaling parameter before computing the LLRs.

An advantage with this possible implementation form is that by scaling the computed decision metric, no loss of information from the transformation operation is at hand and hence the performance of a MIMO detector which uses transformed constellations is unaffected.

In a ninth possible implementation form of a receiving device according to the eight implementation form of the first aspect, the real-valued scaling parameter is based on the type of norm-metric used for the detection.

An advantage with this possible implementation form is that using different real-valued scaling parameters based on the type of norm-metric, the transformed constellations can be used with both L₂-norm and L₁-norm based MIMO detectors.

In a tenth possible implementation form of a receiving device according to the eighth or ninth implementation forms of the first aspect when dependent on the first or second implementation form, the real-valued scaling parameter is dependent on the complex-valued scaling parameter.

An advantage with this possible implementation form is that the correct LLR values for the transmitted bits without loss of information from the transformation operation are obtained.

In an eleventh possible implementation form of a receiving device according to any of the seventh to the tenth implementation forms of the first aspect, further comprising a decoder configured to decode the computed LLRs.

An advantage with this possible implementation form is that it is a convenient way of performing decoding using well known methods.

In a twelfth possible implementation form of a receiving device according to any of the preceding implementation forms of the first aspect or to the first aspect as such, the processing circuit is configured to compute the decision metric by affine-transform at least one of the received MIMO communication signal and a corresponding channel coefficient matrix, compute the decision metric based on the at least one affine-transformed complex-valued symbol constellation and at least one of the affine-transformed received MIMO communication signal and the affine-transformed channel coefficient matrix.

An advantage with this possible implementation form is that the equivalency in terms of performance between a MIMO detector which does not use transformed constellations and a MIMO detector which uses transformed constellations is retained.

According to the twelfth possible implementation form, the affine-transformation of the channel coefficient matrix and the received MIMO communication signal may depend on at least one constellation normalization factor.

According to a second aspect of the application, the above mentioned and other objectives are achieved with a method for a MIMO communication system, the method comprising receiving a MIMO communication signal comprising a plurality of transmit symbols belonging to at least one complex-valued symbol constellation, affine-transforming the at least one complex-valued symbol constellation so as to obtain at least one affine-transformed complex-valued symbol constellation, computing a decision metric based on the at least one affine-transformed complex-valued symbol constellation, detecting the plurality of transmit symbols based on the computed decision metric.

In a first possible implementation form of a method according to the second aspect, the affine-transformation comprises scaling the complex-valued symbol constellation with at least one complex-valued scaling parameter.

In a second possible implementation form of a method according to the first implementation form of the second aspect, the complex-valued scaling parameter has the form 1/β, where β is a complex number.

In a third possible implementation form of a method according to the first or second implementation forms of the second aspect or to the second aspect as such, the affine-transformation comprises shifting the complex-valued symbol constellation with at least one complex-valued shifting parameter.

In a fourth possible implementation form of a method according to the first or second implementation forms of the second aspect or to the second aspect as such, the affine-transformation comprises rotating the complex-valued symbol constellation with at least one complex-valued rotation parameter having unit modulus.

In a fifth possible implementation form of a method according to the third or fourth implementation forms of the first aspect, the plurality of transmit symbols corresponds to different transmission layers, and wherein at least one of the complex-valued shifting parameter and the complex-valued rotation parameter is dependent on the transmission layers.

In a sixth possible implementation form of a method according to any of the second to fifth implementation forms of the second aspect or to the second aspect as such, the detection of the plurality of transmit symbols comprises performing hard-decisions based on the computed decision metric.

In a seventh possible implementation form of a method according to any of the second to fifth implementation forms of the second aspect or to the second aspect as such, the detection of the plurality of transmit symbols comprises computing LLRs for bits corresponding to the plurality of transmit symbols based on the computed decision metric.

In an eight possible implementation form of a method according to the seventh implementation form of the second aspect, the method comprises scaling the computed decision metric using a real-valued scaling parameter before computing the LLRs.

In a ninth possible implementation form of a method according to the eight implementation form of the second aspect, the real-valued scaling parameter is based on the type of norm-metric used for the detection.

In a tenth possible implementation form of a method according to the eighth or ninth implementation forms of the second aspect when dependent on the first or second implementation form, the real-valued scaling parameter is dependent on the complex-valued scaling parameter.

In an eleventh possible implementation form of a method according to any of the seventh to the tenth implementation forms of the second aspect, the method comprises decoding the LLRs using a decoder.

In a twelfth possible implementation form of a method according to any of the preceding implementation forms of the second aspect or to the second aspect as such, the method comprises computing the decision metric by affine-transforming at least one of the received MIMO communication signal and a corresponding channel coefficient matrix, computing the decision metric based on the at least one affine-transformed complex-valued symbol constellation and at least one of the affine-transformed received MIMO communication signal and the affine-transformed channel coefficient matrix.

The advantages of any method according to the second aspect are the same as for the corresponding receiving device according to the first aspect.

Embodiments of the application also relates to a computer program, characterized in code means, which when run by processing means causes said processing means to execute any method according to the application. Further, the application also relates to a computer program product comprising a computer readable medium and said mentioned computer program, wherein said computer program is included in the computer readable medium, and comprises of one or more from the group Read-Only Memory (ROM), Programmable ROM (PROM), Erasable PROM (EPROM), Flash memory, Electrically EPROM (EEPROM) and hard disk drive.

Further applications and advantages of the application will be apparent from the following detailed description.

### BRIEF DESCRIPTION OF THE DRAWINGS

The appended drawings are intended to clarify and explain different embodiments of the application.

FIG. 1 shows a receiving device according to an embodiment of the application.

FIG. 2 shows a corresponding method according to an embodiment of the application.

FIG. 3 illustrates an example affine-transformed 4-Quadrature Amplitude Modulation (QAM) constellation according to an embodiment of the application.

FIG. 4 shows an example affine-transformed 4-QAM constellation according to an embodiment of the application.

FIG. 5 shows an exemplary Constant Multiplier Unit (CMU) implementation according to an embodiment of the application.

FIG. 6 shows another CMU implementation according to embodiment of the application.

FIG. 7 shows another CMU implementation according to an embodiment of the application.

FIG. 8 shows an exemplary communication system according to an embodiment of the application.

### DETAILED DESCRIPTION

In all the MIMO detection methods described above, the decision metric for all or a subset of all possible transmitted signal vectors is computed using the constellation points from the finite-alphabet set Ω, example can be any 2^{2q}-QAM constellation or any other suitable constellations. It has been realized by the inventors that evaluating the decision metric using the standard constellation (i.e., without the proposed applications) doesn't result in reducing the complexity of MIMO detection.

A MIMO system model is firstly presented to provide a deeper understanding of embodiments of the application.

Equation 1 describes such a MIMO model,

y=Hx+n, Equation 1

where, x is the vector of transmitted symbols with size N_{T}×1, in which each element in x belongs to the finite-alphabet set Ω, e.g., any M=2^{2q}-QAM constellation. It is also possible that the elements in x corresponding to different transmission layers (data streams) can belong to different constellations. y is the vector of received signals with size N_{R}×1, H is the channel coefficient matrix with size N_{R}×N_{T}, and n is the vector of noise added on the received signals.

$$x = [ \begin{matrix}{x}_{1} \\ ⋮ \\ {x}_{{N}_{T}}\end{matrix} ] , y = [ \begin{matrix}{y}_{1} \\ ⋮ \\ {y}_{{N}_{R}}\end{matrix} ] , H = [ \begin{matrix}{h}_{11} & ⋯ & {h}_{1 {N}_{R}} \\ ⋮ & & ⋮ \\ {h}_{{N}_{{T}^{1}}} & ⋯ & {h}_{{N}_{T} {N}_{R}}\end{matrix} ] , \\ n = [ \begin{matrix}{n}_{1} \\ ⋮ \\ {n}_{{N}_{R}}\end{matrix} ] \qquad Equation 2$$

Note that, the noise in a MIMO system usually refers to circularly symmetric Additive White Gaussian Noise (AWGN) with E[nn^{H}]=σ²I_{N}_{_{R}}. If not, the optimal solution is to apply the pre-whitening before MIMO detection. The description of MIMO detection below is based on the assumption that noise is AWGN.

In general, Maximum A-Posteriori (MAP) detector has the best performance. MAP detection becomes Maximum Likelihood (ML) detection when the elements in finite-alphabet set Ω have equal probability of transmission. Since the equal probability of transmission for different elements usually holds true, the best receiver refers to ML for most of the cases.

The hard decision of ML detection is shown in Equation 3:

\hat{x}=arg min_{x∈Ω}_{^{N}}_{T}∥y−Hx∥₂² Equation 3

where a term ∥α∥₂² represents the square of the L₂-norm of the vector α of size 1×N, which can be expressed mathematically as ∥α∥₂²=Σ^{N}ₖ₋₁|αₖ|². In some implementations, MIMO signal detection may be performed using the square of the L₁-norm. i.e. \hat{x}=arg min_{x∈Ω}_{^{N}}_{T}∥y−Hx∥₁². L₁-norm of the vector α of size 1×N can be expressed mathematically as ∥α∥₁=Σ^{N}ₖ₌₁|αₖ|. In the following discussion, unless explicitly stated otherwise the notation ∥ ∥² refers to the L₂-norm operation.

The optimal performance of ML is at the cost of high complexity, i.e. 0(M^{N}^{_{T}}). For example, 4-layer transmission with 64 QAM, ML needs to evaluate the ML decision metric in equation 3 for each of the possible candidates of the set Ω^{N}^{_{T}}, which consists of 16777216 hypothesis vectors of x. A brute force evaluation of the metric in Equation 3 for one hypothesis vector in a 4×4 MIMO system consists of 20 complex-valued multiplications and 20 complex-valued additions.

Hence, evaluating the ML metric for 16777216 hypothesis vectors is not practical. One way to reduce the complexity of evaluating the ML decision metric for each of the hypothesis vectors is to transform the ML detection metric using the QR decomposition of the channel coefficient matrix, where H can be decomposed by QR decomposition (can be QL decomposition as well):

$$H = Q * R , \\ R = [ \begin{matrix}{r}_{1 , 1} & ⋯ & {r}_{1 , {N}_{T}} \\ ⋮ & & ⋮ \\ 0 & ⋯ & {r}_{{N}_{T} , {N}_{T}}\end{matrix} ] .$$

After QR decomposition, the ML detection metric can be transformed using the expression z=Q^{H}y=Rx+Q^{H}n as:

$$\begin{matrix}arg {min}_{x ∈ {Ω}^{{N}_{T}}} {‖ y - Hx ‖}^{2} = arg {min}_{x ∈ {Ω}^{{N}_{T}}} {‖ {Q}^{H} y - Rx ‖}^{2} \\ = arg {min}_{x ∈ {Ω}^{{N}_{T}}} {‖ z - Rx ‖}^{2} \\ = arg {min}_{x ∈ {Ω}^{{N}_{T}}} {\sum }_{i = 1}^{{N}_{T}} {\vert {z}_{i} - {\sum }_{j = i}^{{N}_{T}} {r}_{i , j} {x}_{j} \vert}^{2}\end{matrix} \qquad Equation 4$$

The complexity of evaluating the equivalent metric using equation 4 for one hypothesis vector, for 4-layer transmission with 4 receive antennas consists of 14 complex-valued multiplications and 14 complex-valued additions. From here on, when we refer to decision metric, we imply the metric in Equation 3 or equivalent ML metric in Equation 4 or other equivalent forms or their approximations known in the art.

To balance the complexity and performance, many sub-optimal detectors which visit only a subset of all possible hypothesis vectors have been designed. Many of these sub-optimal detectors, such as sphere decoding, K-best algorithm, or QRD-M algorithm, etc., use a tree-search procedure to find the most likely transmitted vector. For performing the tree-search procedure, the ML detection metric is transformed as described above using the QR decomposition, and for each path traversed in the tree, the branch metric |zᵢ−Σⱼ₌ᵢ^{N}^{_{T}}r_{i,j}xⱼ|², and the accumulated metric Σᵢ₌₁^{N}^{_{T}}|zᵢ−Σⱼ₌ᵢ^{N}^{_{T}}r_{i,j}xⱼ|² are computed.

For hard decision decoding, the path which gives the smallest accumulated metric is declared as the most likely transmitted vector. For soft-decision decoding, using the max-log-map approximation, the log-likelihood ratio for the kth bit of xᵢ is computed using:

$${LLR}_{k , i} = \frac{1}{{σ}^{2}} ( {min}_{x ∈ {Ω}^{{N}_{T , {b}_{k , i} = 0}}} {\vert \vert z - Rx \vert \vert}^{2} - {min}_{x ∈ {Ω}^{{N}_{T , {b}_{k , i} = 1}}} {\vert \vert z - Rx \vert \vert}^{2} ) \qquad Equation 5$$

However, as described these conventional solutions still mean high complexity. Accordingly, a receiving device and a method thereof according to embodiments of the present application aim to mitigate or solve the drawbacks of conventional solutions.

FIG. 1 shows a receiving device 100 according to an embodiment of the application. The receiving device 100 may be a standalone device or partially or fully integrated in another device, e.g. a wired or wireless communication device, such as a user device, network node, or modem for wired communications. The receiving device 100 according to the present solution comprises a receiver (or optionally a transceiver) 102 configured to receive a MIMO communication signal y comprising a plurality of transmit symbols belonging to at least one complex-valued symbol constellation Ω. The receiving device 100 further comprises a processing circuit 104 communicably coupled to the receiver 102.

The processing circuit 104 is configured to affine-transform the at least one complex-valued symbol constellation Ω so as to obtain at least one affine-transformed complex-valued symbol constellation Ω′. The processing circuit 104 is further configured to compute a decision metric based on the at least one affine-transformed complex-valued symbol constellation Ω′. The processing circuit 104 is further configured to detect the plurality of transmit symbols based on the computed decision metric.

In an embodiment, the receiving device 100 further comprises an optional decoder 106 configured to decode the LLRs which is shown with dashed lines in FIG. 1. This will be more explained in the following disclosure. FIG. 1 also shows optional antennas 108 configured for wireless communication and an optional modem 110 for wired communication. The receiving device 100 may be configured for wireless communications, wired communications, or combinations thereof.

Further, in an embodiment the processing circuit 104 is configured to compute the decision metric by transforming at least one of the received MIMO communication signal y and a corresponding channel coefficient matrix. The processing circuit 104 is further configured to compute the decision metric based on the at least one affine-transformed complex-valued symbol constellation Ω′ and at least one of the transformed received MIMO communication signal y and the channel coefficient matrix. The transformations of the at least one of the received MIMO communication signal y and the channel coefficient matrix are performed to preserve the equivalence of the original decision metric computed using non-transformed constellations and the new decision metric computed using the transformed constellations.

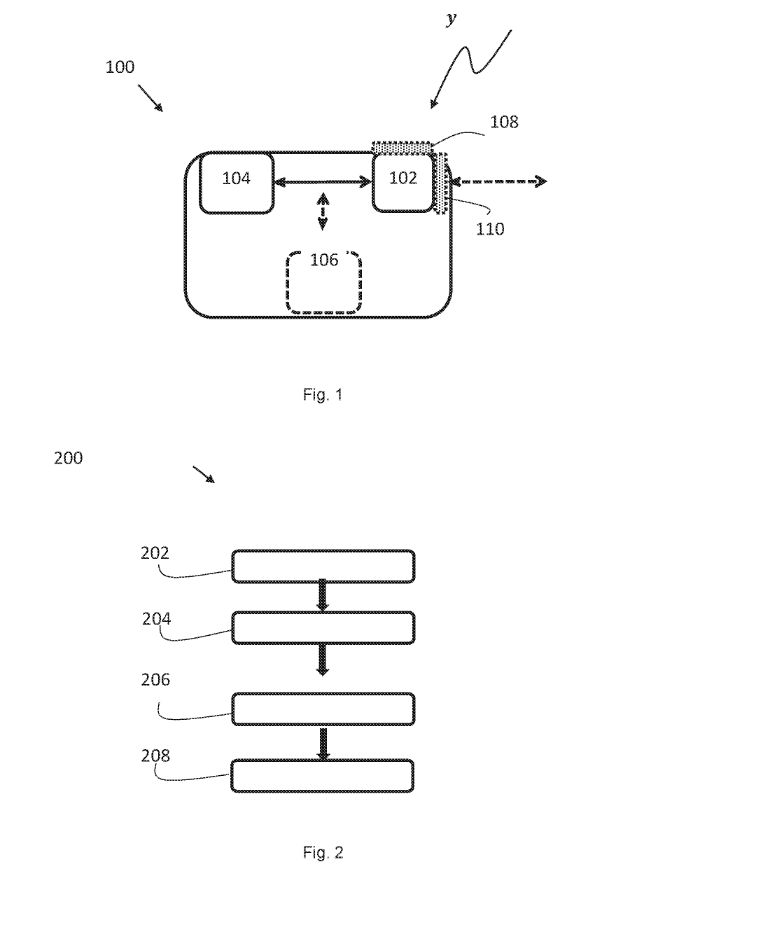

FIG. 2 shows a corresponding method 200 which may be executed in a receiving device 100, such as the one shown in FIG. 1. The method 200 comprises receiving 202 a MIMO communication signal y comprising a plurality of transmit symbols belonging to at least one complex-valued symbol constellation Ω. The method 200 further comprises affine-transforming 204 the at least one complex-valued symbol constellation Ω so as to obtain at least one affine-transformed complex-valued symbol constellation Ω′. The method 200 further comprises computing 206 a decision metric based on the at least one affine-transformed complex-valued symbol constellation Ω. The method 200 finally comprises detecting 208 the plurality of transmit symbols based on the computed decision metric.

The affine-transformation according to the present solution relates to simple linear transformations for providing solutions with reduced complexity. Mainly three basic operations are considered as such linear transformations, i.e. scaling, shifting and rotation.

Accordingly, in an embodiment of the application, the affine-transformation comprises scaling the complex-valued symbol constellation Ω with at least one complex-valued scaling parameter. In yet another embodiment of the application, the complex-valued scaling parameter has the form 1/β, where β is any complex number. In yet another embodiment of the application, the affine-transformation comprises shifting the complex-valued symbol constellation Ω with at least one complex-valued shifting parameter. In yet another embodiment of the application, the affine-transformation comprises rotating the complex-valued symbol constellation Ω with at least one complex-valued rotation parameter having unit modulus.

In the following disclosure, two exemplary embodiments are described in more detail for providing a deeper understanding of the present solution. In the first exemplary embodiment the affine transformation comprises the combination of the shifting and scaling operations of complex-domain symbol constellation. In the second exemplary embodiment the affine transformation comprises the combination of rotation and scaling operations of complex-domain symbol constellation.

In the first exemplary embodiment, we perform the shift and scale operation on the complex-domain symbol constellations corresponding to each transmitted data stream and evaluate the decision metric using the symbols from the transformed constellations. Those experienced in the field can get a similar result by performing a scale operation followed by a shift operation. Here we give an example using the decision metric of equation 4, however those experienced in this field should be able to apply the proposed technique to any equivalent decision metric or its approximations.

As an example, we assume that the symbols of the transmit layer k, 1≤k≤N_{T} come from a 2^{2q}^{ₖ}-QAM constellation Ωₖ with constellation points Ωₖ={(2m−1−2^{q}^{ₖ})+j*(2l−1−2^{q}^{ₖ})|m, l=1, 2, . . . , 2^{q}^{ₖ}}. We shift the constellation Ωₖ by αₖ and scale it by 1/β to obtain the new constellation Ω′ₖ, i.e,

$${Ω}_{k}^{′} = \{ {x}_{k}^{′} \vert {x}_{k}^{′} = \frac{( {x}_{k} + {α}_{k} )}{β} , ∀ {x}_{k} ∈ {Ω}_{k} \} .$$

We evaluate the decision metric, using any MIMO detection method known in the art, and using the points from the transformed constellation Ω′ₖ. The parameters αₖ and β can take any complex-number values.

As an example if αₖ=1+j and β=2 , then Ω′ₖ={(m−2^{q}^{ₖ}⁻¹)±j. (l−2^{q}^{ₖ}⁻¹)|m, l=1, 2, . . . 2^{q}^{ₖ}}. The advantage of this first exemplary embodiment conies from the fact that the points in the constellation Ω′ₖ have constellation points which are powers of integer value 2 and for these constellation points, the arithmetic operations can be performed using simple shift operations hence the simplicity.

Note that the points in Ωₖ have both real and imaginary components which are odd integers. When performing multiplications with the constellation points from Ωₖ one need to perform both shift and addition operations.

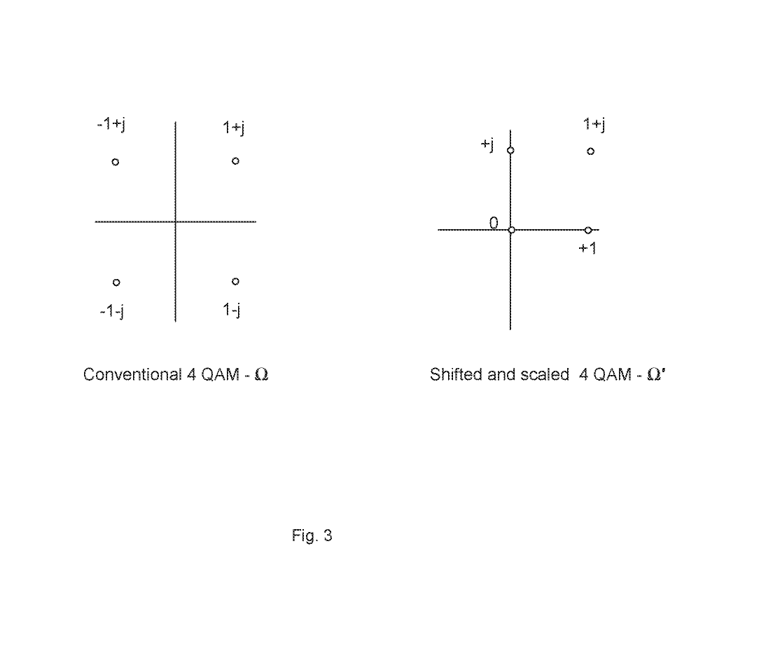

FIG. 3 illustrates an example affine-transformed 4-QAM constellation with α=1+j and β=2.

As we can see from FIG. 3, one of the constellation points from the transformed constellation is 0 and hence for this constellation point, during the MIMO detection procedure, one need not perform any arithmetic operations.

Two of the constellation points in the transformed constellation are on the real and imaginary axis. For these two constellation points, the complexity of performing multiplication with another complex number is reduced.

In an embodiment the plurality of transmit symbols corresponds to different transmission layers, and wherein at least one of the complex-valued shilling parameter is dependent on the transmission layers. Accordingly, one can shift the constellations corresponding to different transmit layers by different shift-factor values and we can write:

$$\begin{matrix}\frac{{‖ z - Rx ‖}^{2}}{{\vert β \vert}^{2}} = \frac{{‖ \begin{matrix}z - R ( x + {[ {α}_{1} {α}_{2} . . . {α}_{{N}_{T}} ]}^{T} - \\ {[ {α}_{1} {α}_{2} . . . {α}_{{N}_{T}} ]}^{T} )\end{matrix} ‖}^{2}}{{\vert β \vert}^{2}} = {‖ {z}^{′} - {Rx}^{′} ‖}^{2} , where & Equation 6 \\ {x}^{′} = \frac{( x + {[ {α}_{1} {α}_{2} . . . {α}_{{N}_{T}} ]}^{T} )}{β} ∈ {Ω}_{1}^{′} \times {Ω}_{2}^{′} \times . . . \times {Ω}_{{N}_{T}}^{′} , and & Equation 7 \\ {z}^{′} = ( z + R \cdot {[ {α}_{1} {α}_{2} . . . {α}_{{N}_{T}} ]}^{T} ) / β . & Equation 8\end{matrix}$$

In Equation 7, Ω′₁×Ω′₂×, . . . ×Ω′_{N}_{_{T}} denotes the Cartesian product of the shift and scaled constellations corresponding to different transmit layers.

From Equation 6, the equivalent ML decision rule can be written as:

$$\begin{matrix}{arg min}_{x ∈ {Ω}_{1} \times {Ω}_{2} \times . . . \times {Ω}_{{N}_{T}}} {‖ z - Rx ‖}^{2} = {arg min}_{{x}^{′} ∈ {Ω}_{1}^{′} \times {Ω}_{2}^{′} \times . . . \times {Ω}_{{N}_{T}}^{′}} {\vert β \vert}^{2} {‖ {z}^{′} - {Rx}^{′} ‖}^{2} \\ = {arg min}_{{x}^{′} ∈ {Ω}_{1}^{′} \times {Ω}_{2}^{′} \times . . . \times {Ω}_{{N}_{T}}^{′}} {\vert β \vert}^{2} {\vert {z}_{i}^{′} - {\sum }_{j = i}^{{N}_{T}} {r}_{i , j} {x}_{j}^{′} \vert}^{2}\end{matrix} \qquad Equation 9$$

From Equation 9. we can conclude that using the present solution, we can compute the decision metric using the symbol vectors from the transformed symbols constellations of Equation 7, the transformed received signal vector of Equation 8 and the scale-factor value β.

Let S₁⊆Ω′₁×Ω′₂×. . . ×Ω′_{N}_{_{T}} denote any subset of the all possible transformed transmit symbol vectors, then

$${\hat{x}}^{′} = {arg min}_{{x}^{′} ∈ {S}_{1}} {‖ {z}^{′} - {Rx}^{′} ‖}^{2}$$

denotes the transformed transmit symbol vector obtained using the hard-decision of the MIMO detection performed using the proposed solution of shifted and scaled constellations, then the transmit symbol vector belonging to non-transformed symbol constellations is obtained using:

\hat{x}=β\hat{x}′−[α₁ α₂ . . . α_{N}_{_{T}}]^{T}. Equation 10

The long-likelihood ratio for the kth bit of ith layer transmit symbol xᵢ belonging to non-transformed symbol constellation can be obtained using the symbol vectors from the transformed symbols constellations of Equation 7, the transformed received signal vector of Equation 8 and the complex-valued scale-factor value β as shown below:

$${LLR}_{k , i} = \frac{{\vert β \vert}^{2}}{{σ}^{2}} ( {min}_{{x}^{′} ∈ {S}_{1} : {b}_{k , i} = 0} {‖ {z}^{′} - {Rx}^{′} ‖}^{2} - {min}_{{x}^{′} ∈ {S}_{1} : {b}_{k , i} = 1} {‖ {z}^{′} - {Rx}^{′} ‖}^{2} ) , \qquad Equation 11$$

where the notation x′∈S₁:b_{k,i}=j implies all the possible transformed transmitted symbol vectors from the set S₁ whose kth bit of ith layer symbol is j.

The following discussion concerns how to handle the case if normalized-constellations are used at the transmitter when employing shifted and scaled constellations for MIMO detection. An example of the normalization factors for well known QAM constellations is given in Table 1 below.

TABLE 1
Scale factor for QAM constellations

QAM Size

| | 4 | 16 | 64 | 256 |
|---|---|---|---|---|
| Normalization | 1/\sqrt{2} | 1/\sqrt{10} | 1/\sqrt{42} | 1/\sqrt{170} |
| factor (γ) | | | | |

If all the elements of the transmit symbol vector xₛ=[x₁γ, . . . , x_{N}_{_{T}}γ]^{T}=γ[x₁, . . . , x_{N}_{_{T}}]^{T}=γx consist of modulation symbols per transmission layer of the same modulation order and are scaled by the same constellation normalization-factor γ, where x₁, . . . , x_{N}_{_{T}} denote the un-normalized constellation symbols we have:

$$\begin{matrix}{‖ z - {Rx}_{s} ‖}^{2} = {‖ [ \begin{matrix}{z}_{1} \\ ⋮ \\ {z}_{{N}_{T}}\end{matrix} ] = γ [ \begin{matrix}{r}_{1 , 1} & … & {r}_{1 , {N}_{T}} \\ ⋮ & ⋱ & ⋮ \\ 0 & … & {r}_{{N}_{T} , {N}_{T}}\end{matrix} ] [ \begin{matrix}{x}_{1} \\ ⋮ \\ {x}_{{N}_{T}}\end{matrix} ] ‖}^{2} \\ = γ {‖ [ \begin{matrix}\frac{{z}_{1}}{γ} \\ ⋮ \\ \frac{{z}_{N}}{γ}\end{matrix} ] - [ \begin{matrix}{r}_{1 , 1} & … & {r}_{1 , N} \\ ⋮ & ⋱ & ⋮ \\ 0 & … & {r}_{N , N}\end{matrix} ] [ \begin{matrix}{x}_{1} \\ ⋮ \\ {x}_{N}\end{matrix} ] ‖}^{2} \\ = {γ}^{2} {‖ {z}_{s} - Rx ‖}^{2} ,\end{matrix} \qquad Equation 12$$

where the z vector is scaled by the common constellation normalization factor to obtain

$${z}_{s} = \frac{1}{γ} z .$$

Using Equation 12, we can apply the following steps for performing MIMO detection using shifted and scaled constellations when all transmission layers consist of symbols from the same normalized constellation:

$$\begin{matrix}Compute {z}_{s} = \frac{1}{γ} z . & Equation 13 \\ Compute {z}_{s}^{′} using \text{:} \\ {z}_{s}^{′} = ( {z}_{s} + R \cdot {[ {α}_{1} {α}_{2} … {α}_{{N}_{T}} ]}^{T} ) / β . & \\ Compute detection metric using {‖ {z}_{s}^{′} - {Rx}^{′} ‖}^{2} , {x}^{′} ∈ {S}_{1} . & \end{matrix}$$

Either perform hard-decision detection using

$${\hat{x}}^{′} = {arg min}_{{x}^{′} ∈ {S}_{1}} {‖ {z}_{s}^{′} - {Rx}^{′} ‖}^{2} ,$$

and obtain the transmitted symbol vector consisting of the normalized non-transformed constellation symbols using:

$${\hat{x}}_{s} = \frac{1}{γ} ( β {\hat{x}}^{′} - {[ {α}_{1} {α}_{2} … {α}_{{N}_{T}} ]}^{T} ) . \qquad Equation 14$$

Or compute the log-likelihood ratio for the loth bit of ith transmit layer symbol xₛ_{ᵢ} belonging to normalized non-transformed symbol constellation using the symbol vectors from the transformed symbols constellations of Equation 7, the transformed received signal vector of Equation 13 and the scale-factor value β as shown below:

$${LLR}_{k , i} = \frac{{γ}^{2} {\vert β \vert}^{2}}{{σ}^{2}} ( {min}_{{x}^{′} ∈ {S}_{1} : {b}_{k , i} = 0} {‖ {z}_{s}^{′} - {Rx}^{′} ‖}^{2} - {min}_{{x}^{′} ∈ {S}_{1} : {b}_{k , i} = 1} {‖ {z}_{s}^{′} - {Rx}^{′} ‖}^{2} ) . \qquad Equation 15$$

For the general case when the elements of the transmit symbol vector xₛ=

[x₁ γ₁, . . . , x_{N}_{_{T}}γ_{N}_{_{T}}]^{T} consists of modulation symbols per layer coming from different constellation that are scaled by different constellation normalization factors γ₁, . . . , γ_{N}_{_{T}}, respectively. x₁, . . . , x_{N}_{_{T}} denote the un-normalized constellation symbols we have:

$$\begin{matrix}\begin{matrix}{‖ z - {Rx}_{s} ‖}^{2} = {‖ [ \begin{matrix}{z}_{1} \\ ⋮ \\ {z}_{{N}_{T}}\end{matrix} ] - [ \begin{matrix}{r}_{1 , 1} & … & {r}_{1 , {N}_{T}} \\ ⋮ & ⋱ & ⋮ \\ 0 & … & {r}_{{N}_{T} , {N}_{T}}\end{matrix} ] [ \begin{matrix}{x}_{1} {γ}_{1} \\ ⋮ \\ {x}_{N} {γ}_{{N}_{T}}\end{matrix} ] ‖}^{2} \\ = {‖ [ \begin{matrix}{z}_{1} \\ ⋮ \\ {z}_{N}\end{matrix} ] - [ \begin{matrix}{r}_{1 , 1} {γ}_{1} & … & {r}_{1 , {N}_{T}} {γ}_{{N}_{T}} \\ ⋮ & ⋱ & ⋮ \\ 0 & … & {r}_{{N}_{T} , {N}_{T}} {γ}_{{N}_{T}}\end{matrix} ] [ \begin{matrix}{x}_{1} \\ ⋮ \\ {x}_{{N}_{T}}\end{matrix} ] ‖}^{2} \\ = {‖ z - {R}_{s} x ‖}^{2} ,\end{matrix} & Equation 16 \\ where {R}_{s} = [ \begin{matrix}{r}_{1 , 1} {γ}_{1} & … & {r}_{1 , {N}_{T}} {γ}_{{N}_{T}} \\ ⋮ & ⋱ & ⋮ \\ 0 & … & {r}_{{N}_{T} , {N}_{T}} {γ}_{{N}_{T}}\end{matrix} ] . & \end{matrix}$$

Using Equation 16, we can apply the following steps for performing MIMO detection using shifted and scaled constellations when different transmission layers consist of symbols from different normalized constellations

$$\begin{matrix}Compute {R}_{s} = [ \begin{matrix}{r}_{1 , 1} {γ}_{1} & … & {r}_{1 , {N}_{T}} {γ}_{{N}_{T}} \\ ⋮ & ⋱ & ⋮ \\ 0 & … & {r}_{{N}_{T} , {N}_{T}} {γ}_{{N}_{T}}\end{matrix} ] . & Equation 17 \\ Compute {z}^{′} using \text{:} \\ {z}^{′} = ( z + {R}_{s} \cdot {[ {α}_{1} {α}_{2} … {α}_{{N}_{T}} ]}^{T} ) / β . & \\ Compute detection metric using {‖ {z}^{′} - {R}_{s} {x}^{′} ‖}^{2} , \\ {x}^{′} ∈ {S}_{1} . & \end{matrix}$$

Either perform hard-decision detection using

$${\hat{x}}^{′} = {arg min}_{{x}^{′} ∈ {S}_{1}} {‖ {z}^{′} - {R}_{s} {x}^{′} ‖}^{2} ,$$

and obtain the transmitted symbol vector consisting of the normalized non-transformed constellation symbols using Equation 10.

Or compute the log-likelihood ratio for the kth bit of ith transmit layer symbol xₛ_{ᵢ} belonging to normalized non-transformed symbol constellation using the symbol vectors from the transformed symbols constellations of Equation 7, the transformed received signal vector of Equation 17 and the scale-factor value β as shown below:

$${LLR}_{k , i} = \frac{{\vert β \vert}^{2}}{{σ}^{2}} ( {min}_{{x}^{′} ∈ {S}_{1} : {b}_{k , i} = 0} {‖ {z}^{′} - {R}_{s} {x}^{′} ‖}^{2} - {min}_{{x}^{′} ∈ {S}_{1} : {b}_{k , i} = 1} {‖ {z}^{′} - {R}_{s} {x}^{′} ‖}^{2} ) \qquad Equation 18$$

In the second exemplary embodiment, we perform the rotation and scale operation on the complex--domain symbol constellation and evaluate the decision metric using the transformed constellation. Those experienced in the field can get a similar result by performing a scale operation followed by a rotation operation. Here we give an example using the decision metric of

Equation 4, however those experienced in this field should be able to apply the proposed technique to any equivalent decision metric or its approximations.

As an example, we assume that the symbols of the transmit layer k, 1≤k≤N_{T} come from a 2²^{_{qk}}-QAM constellation Ωₖ with constellation points Ωₖ={(2m−1−2^{q}^{ₖ})+j*(2l−1−2^{q}^{ₖ})|m, l=1, 2, . . . , 2^{q}^{ₖ}}. We rotate the constellation Ωₖ by e^{jθ}^{ₖ} and scale it by 1/β to obtain the transformed constellation Ω̅ₖ, i.e,

$${\overline{Ω}}_{k} = \{ {\overline{x}}_{k} \vert {\overline{x}}_{k} = \frac{x * {e}^{j {θ}_{k}}}{β} , ∀ {x}_{k} ∈ {Ω}_{k} \} .$$

We evaluate the decision metric (using any MIMO detection method) using the points from the transformed constellation Ω̅ₖ. The parameter θₖ∈[0,2π], 1≤k≤N_{T} and β can take any complex-number value.

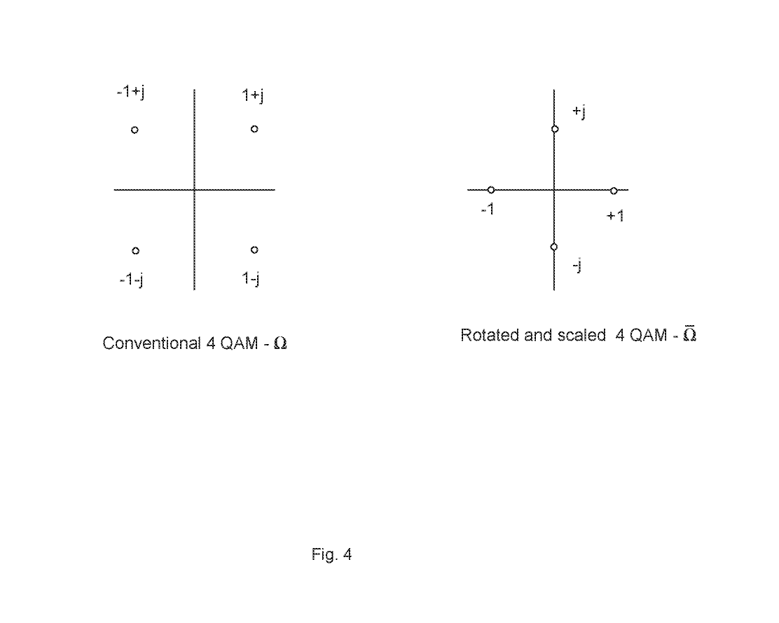

As an example if θ=π/4 and β=\sqrt{2}, the rotated and scaled 4 QAM constellation is shown in FIG. 4. The advantage for the proposed method comes from the fact that the points in the transformed constellation Ω̅ₖ are on the real and imaginary axes as shown in FIG. 4. Hence it is easy to implement the arithmetic operations using the constellation points from the transformed constellation Ω̅ₖ.

Using a further embodiment of present application, one can shift the constellations corresponding to different transmit layers by different shift-factor values as shown below.

$$\begin{matrix} \frac{{‖ z - Rx ‖}^{2}}{{\vert β \vert}^{2}} = \frac{{‖ B ( z - Rx ) ‖}^{2}}{{\vert β \vert}^{2}} = {‖ ( \overline{z} - R \overline{x} ) ‖}^{2} , & Equation 19 \\ where B = [ \begin{matrix}{e}^{j {θ}_{1}} & 0 & … & 0 \\ 0 & {e}^{j {θ}_{2}} & … & 0 \\ ⋮ & ⋮ & ⋮ & ⋮ \\ 0 & 0 & 0 & {e}^{j {θ}_{{N}_{T}}}\end{matrix} ] , & \\ \overline{x} = \frac{1}{β} Bx = {\frac{1}{β} [ ( {e}^{j {θ}_{1}} {x}_{1} ) ( {e}^{j {θ}_{2}} {x}_{2} ) … ( {e}^{j {θ}_{{N}_{T}}} {x}_{{N}_{T}} ) ]}^{T} ∈ {\overline{Ω}}_{1} \times {\overline{Ω}}_{2} \times … \times {\overline{Ω}}_{{N}_{T}} , & Equation 20 \\ and & \\ \overline{z} = \frac{1}{β} Bz = {\frac{1}{β} [ ( {e}^{j {θ}_{1}} {z}_{1} ) ( {e}^{j {θ}_{2}} {z}_{2} ) … ( {e}^{j {θ}_{{N}_{T}}} {z}_{{N}_{T}} ) ]}^{T} . & Equation 21\end{matrix}$$

In Equation 20, Ω̅₁×Ω̅₂×. . . ×Ω̅_{N}_{_{T}} denotes the Cartesian product of the rotated and scaled constellations corresponding to different transmit layers.

From Equation 19, the equivalent ML decision rule can be written as:

$${arg min}_{x ∈ {Ω}_{1} \times {Ω}_{2} \times … \times {Ω}_{{N}_{T}}} {‖ z - Rx ‖}^{2} = {arg min}_{\overline{x} ∈ {\overline{Ω}}_{1} \times {\overline{Ω}}_{2} \times … \times {\overline{Ω}}_{{N}_{T}}} {\vert β \vert}^{2} {‖ ( \overline{z} - R \overline{x} ) ‖}^{2} = {arg min}_{\overline{x} ∈ {\overline{Ω}}_{1} \times {\overline{Ω}}_{2} \times … \times {\overline{Ω}}_{{N}_{T}}} {\vert β \vert}^{2} {\sum }_{i = 1}^{{N}_{T}} {\vert {\overline{z}}_{i} - {\sum }_{l = i}^{{N}_{T}} {r}_{i , l} {\overline{x}}_{l} \vert}^{2} . \qquad Equation 22$$

From Equation 22, we can conclude that using the proposed application, we can compute the decision metric using the symbol vectors from the transformed symbols constellations of Equation 20, the transformed received signal vector of Equation 21 and the scale-factor value β.

Let S₂⊆Ω̅₁×Ω̅₂×. . . ×Ω̅_{N}_{_{T}} denote any subset of the all possible transformed transmit symbol vectors, then

$$\overline{\hat{x}} = {arg min}_{\overline{x} ∈ {S}_{2}} {‖ ( \overline{z} - R \overline{x} ) ‖}^{2}$$

denotes the transformed transmit symbol vector obtained using the hard-decision of the MIMO detection performed using the proposed application of using rotated and scaled constellations, then the transmit symbol vector belonging to non-transformed symbol constellations is obtained using:

\hat{x}=βB⁻¹\hat{x̅}. Equation 23

The log-likelihood ratio for the kth bit of ith layer transmit symbol xᵢ belonging to non-transformed symbol constellation can be obtained using the transformed symbol vectors consisting of elements from the transformed symbol constellation, the transformed received signal vector of Equation 21 and the scale-factor value β as shown below:

$${LLR}_{k , i} = \frac{{\vert β \vert}^{2}}{{σ}^{2}} ( {min}_{\overline{x} ∈ {S}_{2} : {b}_{k , i} = 0} {‖ ( \overline{z} - R \overline{x} ) ‖}^{2} - {min}_{\overline{x} ∈ {S}_{2} : {b}_{k , i} = 1} {‖ ( \overline{z} - R \overline{x} ) ‖}^{2} ) , \qquad Equation 24$$

where the notation x̅∈S₂:b_{k,i}=j implies all the possible transformed transmitted symbol vectors from the set S₂ whose kth bit of ith layer symbol xᵢ is j.

The following discussion relates to how to handle the case when normalized-constellations are used at the transmitter when employing rotated and scaled constellations for MIMO detection. If all the elements of the transmit symbol vector xₛ=[x₁γ, . . . , x_{N}_{_{T}}γ]^{T}=γ[x₁, . . . , x_{N}_{_{T}}]^{T}=γx consists of modulation symbols per transmission layer of the same modulation order and are scaled by the same constellation normalization-factor γ, where x₁, . . . , x_{N}_{_{T}} denote the un-normalized constellation symbols we have:

$$\begin{matrix}{‖ ( z - {Rx}_{s} ) ‖}^{2} = {‖ [ \begin{matrix}{z}_{1} \\ ⋮ \\ {z}_{{N}_{T}}\end{matrix} ] - γ [ \begin{matrix}{r}_{1 , 1} & ⋯ & {r}_{1 , {N}_{T}} \\ ⋮ & ⋱ & ⋮ \\ 0 & ⋯ & {r}_{{N}_{T} , {N}_{T}}\end{matrix} ] [ \begin{matrix}{x}_{1} \\ ⋮ \\ {x}_{{N}_{T}}\end{matrix} ] ‖}^{2} \\ = {γ}^{2} {‖ [ \begin{matrix}\frac{{z}_{1}}{γ} \\ ⋮ \\ \frac{{z}_{N}}{γ}\end{matrix} ] - [ \begin{matrix}{r}_{1 , 1} & ⋯ & {r}_{1 , N} \\ ⋮ & ⋱ & ⋮ \\ 0 & ⋯ & {r}_{N , N}\end{matrix} ] [ \begin{matrix}{x}_{1} \\ ⋮ \\ {x}_{N}\end{matrix} ] ‖}^{2} \\ = {γ}^{2} {‖ {z}_{s} - Rx ‖}^{2}\end{matrix} \qquad Equation 25$$

where

$${z}_{s} = \frac{1}{γ} z .$$

Using Equation 12, we can apply the following steps for performing MIMO detection using rotated and scaled constellations when all transmission layers consist of symbols from the same normalized constellation:

$$Compute {z}_{s} = \frac{1}{γ} z . \\ Compute {\overline{z}}_{s} using \text{:} \\ {\overline{z}}_{s} = \frac{1}{β} {Bz}_{s} . \\ Compute detection metric using {‖ ( {\overline{z}}_{s} - R \overline{x} ) ‖}^{2} , \\ \overline{x} ∈ {S}_{2} . \qquad Equation 26$$

Either perform hard-decision detection using

$$\overline{\hat{x}} = {arg min}_{\overline{x} ∈ {S}_{2}} {‖ ( {\overline{z}}_{s} - R \overline{x} ) ‖}^{2}$$

and obtain the transmitted symbol vector consisting of the normalized non-transformed constellation symbols using:

$${\hat{x}}_{s} = \frac{β {B}^{- 2} \overline{\hat{x}}}{γ} . \qquad Equation 27$$

Or compute the log-likelihood ratio for the kth bit of ith transmit layer symbol xₛ_{ᵢ} belonging to normalized non-transformed symbol constellation using transformed symbol vectors consisting of elements from the transformed symbol constellations the transformed received signal vector of Equation 26 and the scale-factor value β as shown below:

$${LLR}_{k , i} = \frac{{γ}^{2} {\vert β \vert}^{2}}{{σ}^{2}} ( {min}_{\overline{x} ∈ {S}_{2} : {b}_{k , i} = 0} {‖ ( {\overline{z}}_{s} - R \overline{x} ) ‖}^{2} - {min}_{\overline{x} ∈ {S}_{2} : {b}_{k , i} = 1} {‖ ( {\overline{z}}_{s} - R \overline{x} ) ‖}^{2} ) . \qquad Equation 28$$

For the general case when the elements of the transmit symbol vector xₛ=[x₁γ₁, . . . , x_{N}_{_{T}}γ_{N}_{_{T}}]^{T} consists of modulation symbols per layer coming from different constellation that are scaled by different constellation scale factors γ₁, . . . γ_{N}_{_{T}}, respectively. x₁, . . . , x_{N}_{_{T}} denote the un-normalized QAM symbols. In this case, we have:

$${‖ ( z - {Rx}_{s} ) ‖}^{2} = {‖ [ \begin{matrix}{z}_{1} \\ ⋮ \\ {z}_{{N}_{T}}\end{matrix} ] - [ \begin{matrix}{r}_{1 , 1} & ⋯ & {r}_{1 , {N}_{T}} \\ ⋮ & ⋱ & ⋮ \\ 0 & ⋯ & {r}_{{N}_{T} , {N}_{T}}\end{matrix} ] [ \begin{matrix}{x}_{1} {γ}_{1} \\ ⋮ \\ {x}_{N} {γ}_{{N}_{T}}\end{matrix} ] ‖}^{2} = {‖ [ \begin{matrix}{z}_{1} \\ ⋮ \\ {z}_{N}\end{matrix} ] - [ \begin{matrix}{r}_{1 , 1} {γ}_{1} & ⋯ & {r}_{1 , {N}_{T}} {γ}_{{N}_{T}} \\ ⋮ & ⋱ & ⋮ \\ 0 & ⋯ & {r}_{{N}_{T} , {N}_{T}} {γ}_{{N}_{T}}\end{matrix} ] [ \begin{matrix}{x}_{1} \\ ⋮ \\ {x}_{{N}_{T}}\end{matrix} ] ‖}^{2} = {‖ z - {R}_{s} x ‖}^{2} , \\ where {R}_{s} = [ \begin{matrix}{r}_{1 , 1} {γ}_{1} & ⋯ & {r}_{1 , {N}_{T}} {γ}_{{N}_{T}} \\ ⋮ & ⋱ & ⋮ \\ 0 & ⋯ & {r}_{{N}_{T} , {N}_{T}} {γ}_{{N}_{T}}\end{matrix} ] . \qquad Equation 29$$

Using Equation 29, we can apply the following steps for performing MIMO detection using rotated and scaled constellations when different transmission layers consist of symbols from different normalized constellations:

$$Compute {R}_{s} = [ \begin{matrix}{r}_{1 , 1} {γ}_{1} & ⋯ & {r}_{1 , {N}_{T}} {γ}_{{N}_{T}} \\ ⋮ & ⋱ & ⋮ \\ 0 & ⋯ & {r}_{{N}_{T} , {N}_{T}} {γ}_{{N}_{T}}\end{matrix} ] . \\ Compute \overline{z} using Equation 20.$$

$$Compute detection metric using {‖ ( \overline{z} - {R}_{s} \overline{x} ) ‖}^{2} , \overline{x} ∈ {S}_{2} .$$

Either perform hard-decision detection using

$$\overline{\hat{x}} = {arg min }_{\overline{x} ∈ {S}_{2}} {‖ ( \overline{z} - {R}_{s} \overline{x} ) ‖}^{2} ,$$

and obtain the transmitted symbol vector consisting of the normalized non-transformed constellation symbols using Equation 23.

Or compute the log-likelihood ratio for the kth bit of ith transmit layer symbol xₛ_{ᵢ} belonging to normalized non-transformed symbol constellation using transformed symbol vectors consisting of elements from the transformed symbol constellations, the transformed received signal vector of Equation 20 and the scale-factor value β as shown below:

$${LLR}_{k , i} = \frac{{\vert β \vert}^{2}}{{σ}^{2}} ( {min}_{\overline{x} ∈ {S}_{2} : {b}_{k , i} = 0} {‖ ( \overline{z} - {R}_{s} \overline{x} ) ‖}^{2} - {min}_{\overline{x} ∈ {S}_{2} : {b}_{k , i} = 1} {‖ ( \overline{z} - {R}_{s} \overline{x} ) ‖}^{2} ) . \qquad Equation 30$$

In a further embodiment related to the second exemplary embodiment, MIMO detection operations can be performed using L₁-norm metric to further reduce the complexity of MIMO detection. When considering L₁-norm based MIMO detection, we have:

$$\frac{{‖ z - Rx ‖}_{1}^{2}}{{\vert β \vert}^{2}} = \frac{{‖ B ( z - Rx ) ‖}_{1}^{2}}{{\vert β \vert}^{2}} = {‖ \overline{z} - R \overline{x} ‖}_{1}^{2} . \qquad Equation 31$$

From Equation 31, the equivalent ML decision rule when employing L₁-norm metric can be written as:

$${arg min}_{x ∈ {Ω}_{1} \times {Ω}_{2} \times … \times {Ω}_{{N}_{T}}} {‖ z - Rx ‖}_{1}^{2} = {arg min}_{\overline{x} ∈ {\overline{Ω}}_{1} \times {\overline{Ω}}_{2} \times … \times {\overline{Ω}}_{{N}_{T}}} {\vert β \vert}^{2} ⋆ {‖ \overline{z} - R \overline{x} ‖}_{1}^{2} = {arg min}_{\overline{x} ∈ {\overline{Ω}}_{1} \times {\overline{Ω}}_{2} \times … \times {\overline{Ω}}_{{N}_{T}}} {\vert β \vert}^{2} ⋆ {( {\sum }_{i = 1}^{{N}_{T}} \vert {\overline{z}}_{i} - {\sum }_{l = i}^{{N}_{T}} {r}_{i , l} {\overline{x}}_{l} \vert )}^{2} . \qquad Equation 32$$

From Equation 32, we can conclude that using the proposed application, we can compute the L₁-norm based decision metric using transformed symbol vectors consisting of elements from the transformed symbol constellations, the transformed received signal vector of Equation 21 and the complex-valued scale-factor value β.

If

$${\overline{\hat{x}}}_{L 1} = {arg min }_{\overline{x} ∈ {S}_{2}} {‖ ( \overline{z} - R \overline{x} ) ‖}_{1}^{2}$$

denotes the transformed transmit symbol vector obtained using the hard-decision of the L₁-norm based. MIMO detection performed using the proposed application of using rotated and scaled constellations, then the transmit symbol vector belonging to non-transformed symbol constellations is obtained using:

\hat{x}=βB⁻¹\hat{x̅}_{L1}. Equation 33

When employing L₁-norm based MIMO detection, the log-likelihood ratio for the kth bit of ith layer transmit symbol xᵢ belonging to non-transformed symbol constellation can be obtained using transformed symbol vectors consisting of elements from the transformed symbol constellation, the transformed received signal vector of Equation 21, the complex-valued scale-factor value β and a correction factor δ which takes into account for the use of L₁-norm instead of L₂-norm as shown below:

$${LLR}_{k , i} = \frac{δ {\vert β \vert}^{2}}{{σ}^{2}} ( {min}_{\overline{x} ∈ {S}_{2} : {b}_{k , i} = 0} {‖ ( \overline{z} - R \overline{x} ) ‖}_{1}^{2} - {min}_{\overline{x} ∈ {S}_{2} : {b}_{k , i} = 1} {‖ ( \overline{z} - R \overline{x} ) ‖}_{1}^{2} ) \qquad Equation 34$$

Aforementioned embodiments of the application introduce an innovative receiving device 100 and corresponding method 200 to reduce the complexity of any MIMO detection. An advantage is that by doing a simple transformation of the constellation, we can achieve a complexity reduction for performing arithmetic operations.

The processing circuit 104 of the receiving device 100 may in one embodiment be a CMU. However, according to another embodiment the processing circuit 104 may be a Digital Signal Processor (DSP) configured to execute the present solution.

Below we illustrate the advantage using the example of 4-QAM constellation in a CMU implementation example. To show the advantage of the present solution, we simply consider the multiplication of any given complex number with a point from the 4-QAM constellation. The present solution is however not limited to 4-QAM or QAM which is readily understood by the skilled person.

Let us assume g=(a+jb) is any given complex number and we have to perform the multiplication gxⱼ using a CMU, where xⱼ belongs to the conventional 4-QAM constellation, i.e., xⱼ∈Ω={±1±j}.

To implement gxⱼ , we have using a constant multiplier circuit implementation:

(a+jb)(1+j)=(a−b)+j(a+b);

(a+jb)(1−j)=(a+b)+j(a−b);

(a+jb)(−1−j)=−(a+jb)(1+j); and

(a+jb)(−1+j)=−(a+jb)(1−j).

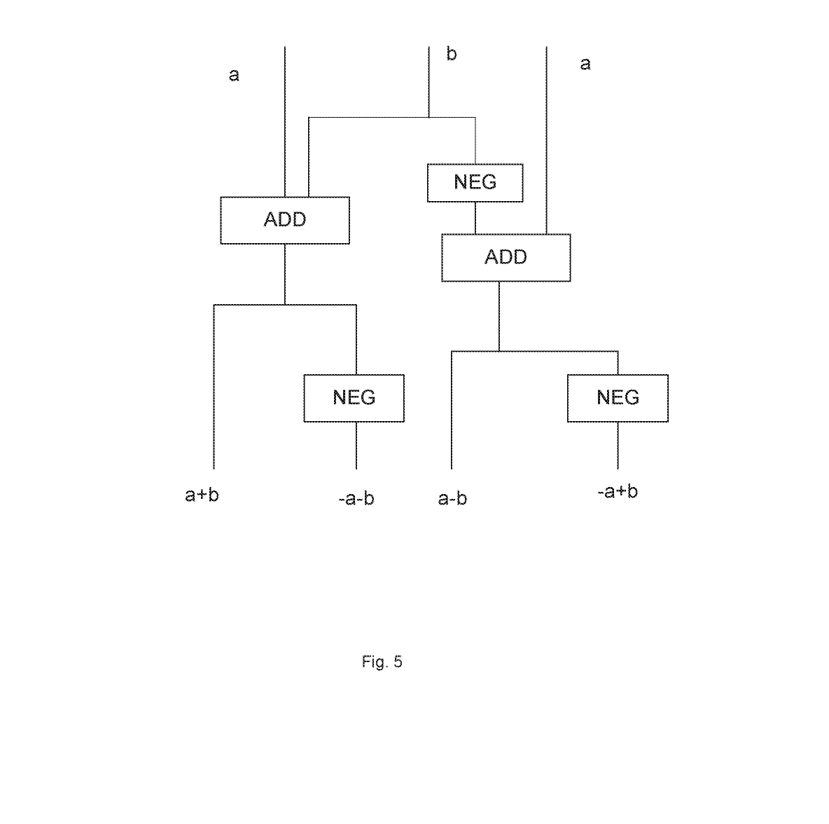

The distinct output terms we need are (a+b), (a−b), −(a+b) and −(a−b) . Hence, we would need two adders (ADD in FIGS. 5 to 7) to perform two additions (a+b) and (a−b) and a total of three negators (NEG in FIGS. 5 to 7) one to perform −b, two more negators to negate (a+b) and (a−b) are required to implement the CMU as shown in FIG. 5. The CMU circuit implementation in FIG. 5 shows the operations required to perform gxⱼ where g=a+jb and xⱼ∈Ω={±1±j}.

Critical path is defined as the path that requires the largest number of arithmetic operations, e.g. additions or negation. Critical path is a metric for the logical delay of the CMU. For 4-QAM using the conventional constellation, critical path length is 3 corresponding to implementation of (a+jb)(−1−j), which requires one negation at the input to get −b and one addition (in parallel) to compute (a+b) and (a−b) one more negation (in parallel) to negate the output of adders.

If we use the shifted and scaled constellation during the MIMO detection procedure, we have to perform multiplications gx′ⱼ, where x′ⱼ belongs to the shifted and scaled 4-QAM constellation Ω′, i.e., x′ⱼ∈Ω′={0, +1, +j, 1+j}, To implement gx′ⱼ we have:

(a+jb)(0)=(0)+j(0);

(a+jb)(+j)=−(b)+j(a);

(a+jb)(1)=a+jb; and

(a+jb)(1+j)=(a−b)+j(a+b).

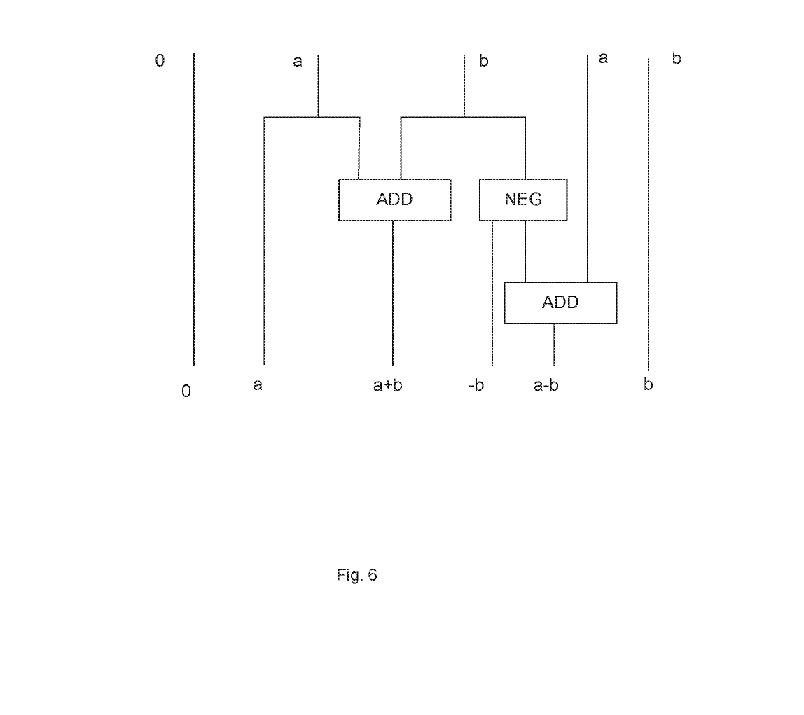

The distinct outputs required at the CMU are 0, a, b, −b, a+b and a−b. In this case, we would still need 2 adders but 1 negator is sufficient for the CMU implementation as shown in FIG. 6. FIG. 6 shows a CMU circuit implementation required for performing gx′ⱼ with g=a+jb and x′ⱼ∈Ω′={0, +1, +j, 1+j}. The critical path length of the circuit shown in FIG. 6 is 2. However, only one constellation point is at critical length. Two constellation points does not require any arithmetic operations and one constellation point requires only one arithmetic operation. The CMU circuit implementation shown in FIG. 6 is for gx′ᵢ where g=a+jb and x′ⱼ∈Ω′={0, +1, +j, 1+j}.

If we use the rotated and scaled constellation during the MIMO detection procedure, we have to perform multiplications gx̅ⱼ, where x̅ⱼ belongs to the rotated and scaled 4-QAM constellation Ω̅, i.e., x̅ⱼ∈Ω̅={±1, ±j}. To implement gx̅ⱼ we have:

(a+jb)(1)=a+jb;

(a+jb)(−1)=−a−jb;

(a+jb)(j)=−b+ja;

(a+jb)(−j)=b−ja.

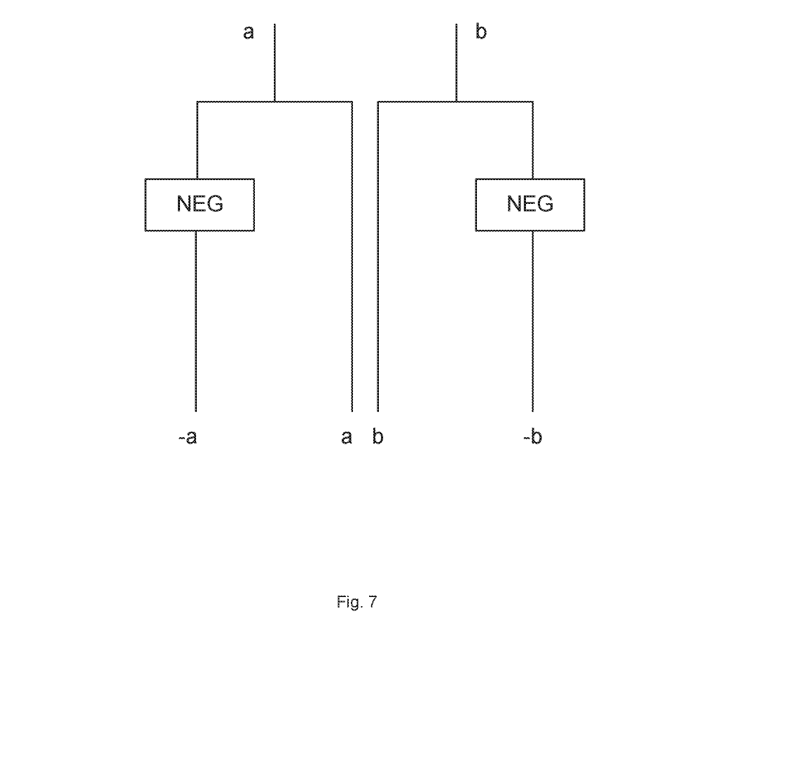

For the output, we only need a, b, −a and −b. Hence, we will not need any adders in this case for the CMU implementation as shown in FIG. 7. FIG. 7 shows a CMU circuit implementation required for performing gx̅ⱼ with g=a+jb and x̅ⱼ∈Ω̅={±1, ±j}. The critical length of the circuit shown in FIG. 7 is 1 and we would only need 2 negators to implement the CMU circuit, The CMU circuit implementation in FIG. 7 is shown for gx̅ⱼ where g=a+jb and x̅ⱼ∈Ω̅={±1, ±j}.

Similar analysis can be done for higher order constellations and Table 2 below summarizes the advantage of proposed solution in terms of the circuit complexity of the CMUs required to perform one complex-domain multiplication. Table 2 contains the number of adders, number of negators required and the critical path length of a CMU circuit implementation for performing the complex multiplication with the points from transformed and non-transformed QAM constellations.

TABLE 2
Comparison of various methods in terms of CMU
circuit complexity for different QAM sizes.

| | Adders | | | | Negators | | | | Critical Length | | | |
|---|---|---|---|---|---|---|---|---|---|---|---|---|
| | QAM Size | | | | | | | | | | | |
| | 4 | 16 | 64 | 256 | 4 | 16 | 64 | 256 | 4 | 16 | 64 | 256 |
| Conventional | 2 | 10 | 38 | 142 | 2 | 10 | 36 | 140 | 3 | 4 | 5 | 5 |
| Method | | | | | | | | | | | | |
| Shifted and | 2 | 6 | 26 | 106 | 1 | 7 | 27 | 107 | 2 | 3 | 4 | 5 |
| scaled method | | | | | | | | | | | | |
| Rotated and | 0 | 6 | 32 | 134 | 2 | 9 | 40 | 146 | 1 | 9 | 4 | 5 |
| scaled method | | | | | | | | | | | | |

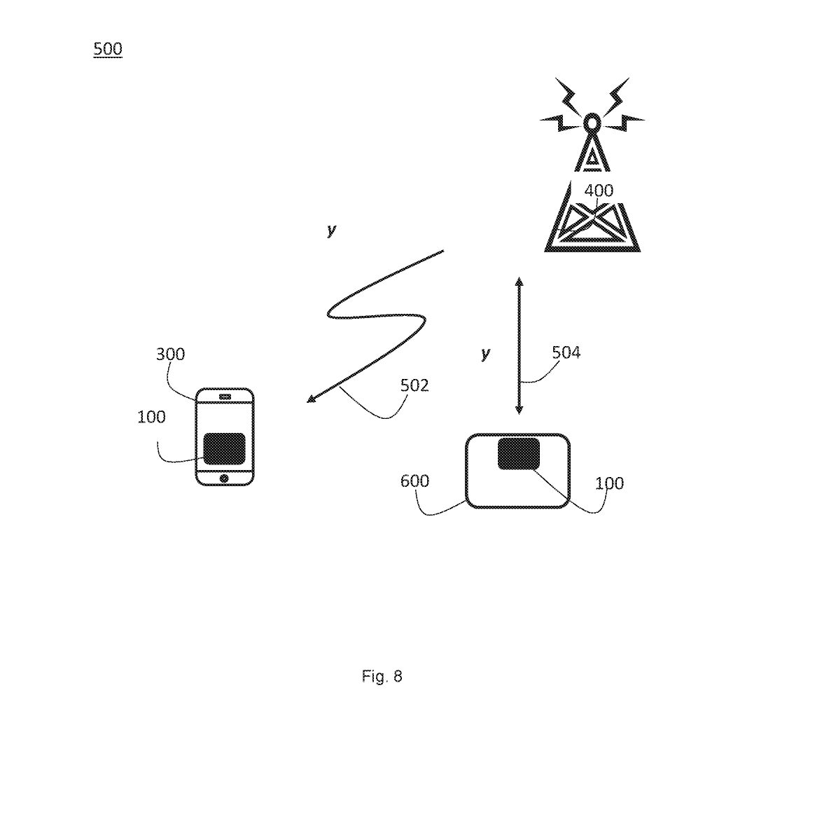

Finally, FIG. 8 shows an exemplary communication system 500 according to an embodiment of the application. The communication system 500 is in this particular example a combined wireless and wired communication system. The communication system 500 comprises a user device 300 which includes a receiving device 100 according to the present solution. The communication system 500 further comprises at least one network node 400, e.g. a base station, The network node is configured to transmit MEMO signal y to the user device 300 in the downlink 502. Upon reception of the MIMO signal the receiving device 100 of the user device processes the MIMO signal according to the present solution. The communication system 500 also comprises a wired communication device 600 comprising a receiving device 100 according to the present solution. The wired communication device 600 is configured to receive a MIMO signal y from the network node 400 over a wired communication link, The receiving device 100 of the wired communication device 600 processes the MIMO signal according to the, present solution.

A network node 400 or an access node or an access point or a base station, e.g., a Radio Base Station (RBS), which in some networks may be referred to as transmitter, “eNB”, “eNodeB”, “NodeB” or “B node”, depending on the technology and terminology used. The network nodes may be of different classes such as, e.g., macro eNodeB, home eNodeB or pico base station, based on transmission power and thereby also cell size. The radio network node can be a Station (STA), which is any device that contains the Institute of Electrical and Electronics Engineers (IEEE) 802.11-conformant Media Access Control (MAC) and Physical Layer (PHY) interface to the Wireless Medium (WM). The network node 400 may also be a network node in a wired communication system. Further, standards promulgated by the IEEE, the Internet Engineering Task Force (IETF), the International Telecommunications Union (ITU), the 3rd Generation Partnership Project (3GPP) standards, fifth-generation (5G) standards and so forth are supported. In various embodiments, the network node 400 may communicate information according to one or more IEEE 802 standards including IEEE 802.11 standards (e.g., 802.11a, b, g/h, j, n, and variants) for WLANs and/or 802.16 standards (e.g., 802.16-2004, 802.16.2-2004, 802.16e, 802.16f, and variants) for Wireless Metropolitan Area Networks (WMANs), and/or 3GPP LTE standards. The network node 400 may communicate information according to one or more of the Digital Video Broadcasting Terrestrial (DVB-T) broadcasting standard and the High performance radio Local Area Network (HiperLAN) standard.

A user device 300 may be any of a User Equipment (UE), mobile station (MS), wireless terminal or mobile terminal which is enabled to communicate wirelessly in a wireless communication system, sometimes also referred to as a cellular radio system. The UE may further be referred to as mobile telephones, cellular telephones, computer tablets or laptops with wireless capability, The UEs in the present context may be, for example, portable, pocket-storable, hand-held, computer-comprised, or vehicle-mounted mobile devices, enabled to communicate voice or data, via the radio access network, with another entity, such as another receiver or a server. The UE can be a STA, which is any device that contains an IEEE 802.11-conformant MAC and PHY interface to the WM. Further, standards promulgated by the IEEE, the IETF, the ITU, the 3GPP standards, 5G standards and so forth, are supported. In various embodiments, the receiving device 100 may communicate information according to one or more IEEE 802 standards including IEEE 802.11 standards (e.g., 802.11a, b, g/h, j, n, and variants) for WLANs and/or 802.16 standards (e.g., 802.16-2004, 802,16.2-2004, 802.16e, 802.16f and variants) for WMANs, and/or 3GPP LIE standards. The receiving device 100 may communicate information according to one or more of the DVB-T broadcasting standard and the HiperLAN standard.

A wired communication device 600 may be a computer, stationary terminal, any device compatible with Digital Subscriber Line (DSL) technologies. Examples of DSL technologies include those defined by standards including asymmetric DSL 2 (ADSL2), very-high-speed DSL (VDSL), very-high-speed DSL 2 (VDSL2), G. vector, and G. fast, which is a future standard to be issued by the International Telecommunication Union Telecommunication Standardization Sector (ITU-T) Study Group 15 (SG15).

Furthermore, any methods according to embodiments of the application may implemented in a computer program, having code means, which when run by processing means causes the processing means to execute the steps of the method. The computer program is included in a computer readable medium of a computer program product. The computer readable medium may comprises of essentially any memory, such as a ROM, a PROM, an EPROM, a Flash memory, an EEPROM, or a hard disk drive.

Moreover, it is realized by the skilled person that the receiving device 100 comprise the necessary communication capabilities in the form of e.g., functions, means, units, elements, etc., for performing the present solution, Examples of other such means, units, elements and functions are processors, memory, buffers, control logic, encoders, decoders, rate matchers, de-rate matchers, mapping units, multipliers, decision units, selecting units, switches, interleavers, de-interleavers, modulators, demodulators, inputs, outputs, antennas, amplifiers, receiver units, transmitter units, DSPs, MSDs, trellis-coded modulation (TCM) encoder, TCM decoder, power supply units, power feeders, communication interfaces, communication protocols, etc. which are suitably arranged together for performing the present solution.

Especially, the processing circuit 104 of the present receiving device 100 may in an embodiment comprise, e.g., one or more instances of a Central Processing Unit (CPU), a processing unit, a processing circuit, a processor, an Application Specific Integrated Circuit (ASIC), a microprocessor, or other processing logic that may interpret and execute instructions. The expression “processor” may thus represent a processing circuitry comprising a plurality of processing circuits, such as, e.g., any, some or all of the ones mentioned above. The processing circuitry may further perform data processing functions for inputting, outputting, and processing of data comprising data buffering and device control functions, such as call processing control, user interface control, or the like.

Finally, it should be understood that the application is not limited to the embodiments described above, but also relates to and incorporates all embodiments within the scope of the appended independent claims.

1. A receiving device for a Multiple Input Multiple Output (MIMO) communication system, comprising:
a receiver configured to receive a MIMO communication signal comprising a plurality of transmit symbols belonging to at least one complex-valued symbol constellation; and
a processing circuit coupled to the receiver and configured to:
affine-transform the at least one complex-valued symbol constellation to obtain at least one affine-transformed complex-valued symbol constellation;
compute a decision metric based on the at least one affine-transformed complex-valued symbol constellation; and
detect the transmit symbols based on the computed decision metric.

2. The receiving device of claim 1, wherein: in a manner of affine-transforming the at least one complex-valued symbol constellation, the processing circuit is further configured to scale the at least one complex-valued symbol constellation with at least one complex-valued scaling parameter.

3. The receiving device of claim 2, wherein the at least one complex-valued scaling parameter has a form 1/β, and the β being a complex number.

4. The receiving device of claim 1, wherein: in a manner of affine-transforming the at least one complex-valued symbol constellation, the processing circuit is further configured to shift the at least one complex-valued symbol constellation with at least one complex-valued shifting parameter.

5. The receiving device of claim 1, wherein: in a manner of affine-transforming the at least one complex-valued symbol constellation, the processing circuit is further configured to rotate the at least one complex-valued symbol constellation with at least one complex-valued rotation parameter having unit modulus.

6. The receiving device of claim 4, wherein the transmit symbols correspond to different transmission layers, and the at least one complex-valued shifting parameter and at least one complex-valued rotation parameter being based on the different transmission layers.

7. The receiving device of claim 1, wherein in a manner of detecting the transmit symbols, the processing circuit is further configured to perform hard-decisions based on the computed decision metric.

8. The receiving device of claim 1, wherein in a manner of detecting the transmit symbols, the processing circuit is further configured to compute Log Likelihood Ratios (LLRs) for bits corresponding to the transmit symbols based on the computed decision metric.

9. The receiving device of claim 8, wherein the processing circuit is further configured to scale the computed decision metric using a real-valued scaling parameter before computing the LLRs.

10. The receiving device of claim 9, wherein the real-valued scaling parameter is based on a type of norm-metric used for detecting the transmit symbols.

11. The receiving device of claim 9, wherein the real-valued scaling parameter is dependent complex-valued scaling parameter.

12. The receiving device of claim 8, further comprising a decoder coupled to the processing circuit and configured to decode the computed LLRs.

13. The receiving device of claim 1, wherein in a manner of computing the decision metric, the processing circuit is further configured to: affine-transform at least one of the received MIMO communication signal or a corresponding channel coefficient matrix; and
compute the decision metric based on the at least one affine-transformed complex-valued symbol constellation and the affine-transformed received MIMO communication signal or the affine-transformed channel coefficient matrix.

14. A method for a Multiple Input Multiple Output (MIMO) communication system, comprising:
receiving a MIMO communication signal comprising a plurality of transmit symbols belonging to at least one complex-valued symbol constellation;
affine-transforming the at least one complex-valued symbol constellation to obtain at least one affine-transformed complex-valued symbol constellation;
computing a decision metric based on the at least one affine-transformed complex-valued symbol constellation; and
detecting the transmit symbols based on the computed decision metric.

15. The method of claim 14, wherein affine-transforming the at least one complex-valued symbol constellation comprises scaling the at least one complex-valued symbol constellation with at least one complex-valued scaling parameter.

16. The method of claim 15, wherein the at least one complex-valued scaling parameter has a form 1/β, and the β being a complex number.

17. The method of claim 14, wherein affine-transforming the at least one complex-valued symbol constellation comprises shifting the at least one complex-valued symbol constellation with at least one complex-valued shifting parameter.

18. The method of claim 14, wherein affine-transforming the at least one complex-valued symbol constellation comprises rotating the at least one complex-valued symbol constellation with at least one complex-valued rotation parameter having unit modulus.

19. The method of claim 17, wherein the transmit symbols correspond to different transmission layers, and the at least one complex-valued shifting parameter and at least one complex-valued rotation parameter being based on the different transmission layers.

20. A non-transitory computer readable storage medium comprising computer program with a program code, the programming code causing a computer to:
receive a Multiple Input Multiple Output (MIMO) communication signal comprising a plurality of transmit symbols belonging to at least one complex-valued symbol constellation;
affine-transform the at least one complex-valued symbol constellation to obtain at least one affine-transformed complex-valued symbol constellation;
compute a decision metric based on the at least one affine-transformed complex-valued symbol constellation; and
detect the transmit symbols based on the computed decision metric.
